(19) United States
(12) Patent Application Publication
(10) Pub. No.: US 2004/0038709 A1
(43) Pub. Date: Feb. 26, 2004

(54) Cellular and phone line connection

(76) Inventor: David Reyad Marks, San Jose, CA (US)

Correspondence Address: DAVID MARKS, P.O. BOX 56168, SAN JOSE, CA, 95156-6168, US

(21) Appl. No.: 10/142,721

(22) Filed: Aug. 22, 2002

(51) Int. Cl. H04B 1/38

(52) U.S. Cl. 455/557; 455/405

(57) ABSTRACT

Dear U.S. PTO Commissioner.

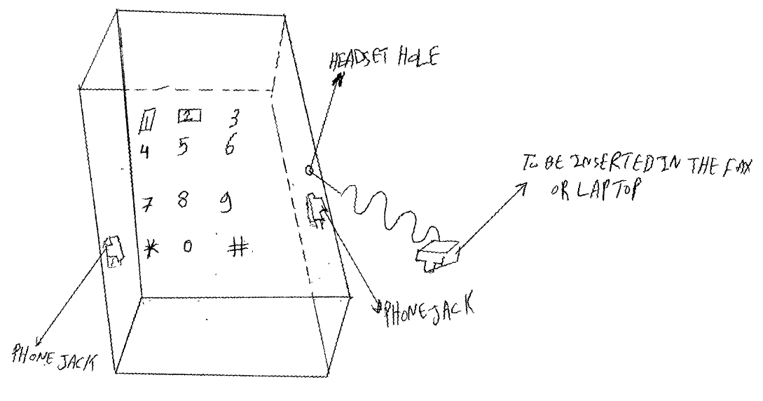

I'm answering your letter which was sent to me on Sep. 24, 2002.

The way this invention is going to work is as follows:

The cell phone uses satellite signals as all other signals for the TV or home phone since it is the same we use to send a fax or receive internet connection so we can use the internet outdoors, so with that connection we with an internal modem in the cell or external modem with the connection I invented or no modem for connecting it to the home line and use the nationwide long distance and also fax papers without paying long distance.

The phone also has to have a groove in it which looks like the phone jack to connect that connection.

For more information please feel free to call me at my numbers or mail me at me above mentioned address.

Dear U.S. PTO officer

I'm writing regarding my patent application of which needs some specifications. The specifications are as follows:

As the matter of fact there is communication line in any cell phone and everyone have sometimes unlimited minutes on the cell phone as AT& T and METRO.PCS. So why don't we use these minutes to access the internet without having a phone line, but using only the cell phone signal line. Also instead of paying long distance to send a fax we can use the cell phone minutes and signal to send a fax by connecting the cell phone to the fax.

For more information please feel free to call me at either number or mail me at my address.

What I claim as my invention is that

1. It will enable us to use the internet outdoors without having a phone line indoors:

2. Also use the cell signals to send a fax without paying long distance call, because all cells has a long distance plan in their extreme or unlimited minutes.

3. It will enables us to eliminate the home phone line because we have the internet outdoors and a cell phone with unlimited minutes as what AT& T started 24/7 Plan and METRO.PCS as well.
For more information please feel free to call me at my numbers or mail me at me above mentioned address.
Yours truly
David Marks
